(19) United States
(12) Patent Application Publication
(10) Pub. No.: US 2014/0030165 A1
(43) Pub. Date: Jan. 30, 2014

(54) MICROFLUIDIC DEVICES HAVING SOLVENT-RESISTANT COATING AND METHOD OF MANUFACTURE THEREOF

(71) Applicants: Carson Riche, Zionsville, PA (US); Noah Malmstadt, Altadena, CA (US); Brandon Marin, West Covina, CA (US); Malancha Gupta, Pasadena, CA (US)

(72) Inventors: Noah Malmstadt, Altadena, CA (US); Malancha Gupta, Pasadena, CA (US); Carson Riche, Zionsville, PA (US); Brandon Marin, West Covina, CA (US)

(73) Assignee: UNIVERSITY OF SOUTHERN CALIFORNIA, Los Angeles, CA (US)

(21) Appl. No.: 13/951,990

(22) Filed: Jul. 26, 2013

Related U.S. Application Data
(60) Provisional application No. 61/676,680, filed on Jul. 27, 2012.

(51) Int. Cl. B01L 3/00

(52) U.S. Cl. CPC B01L 3/502707
USPC 422/502; 427/255.39; 427/237

(57) ABSTRACT

A method of coating a substrate, such as a microfluidic device having an interior surface, includes heating a gas including a perfluoroacrylate, a crosslinker and an initiator at a first temperature, maintaining the substrate at a second temperature lower than the first temperature in a reaction chamber, exposing the heated gas to the substrate in the reaction chamber, and reacting the perfluoroacrylate with the initiator and crosslinker to form a polymer coating on the surface of the substrate.

### CROSS-REFERENCE TO RELATED APPLICATIONS

This application is based upon and claims priority to U.S. Provisional Patent Application No. 61/676,680, entitled “SOLVENT-RESISTANT BARRIER FILMS COATED FROM THE VAPOR PHASE ONTO SEALED MICROFLUIDIC CHANNEL” filed Jul. 27, 2012, attorney docket number 028080-0764, the entire contents of which are incorporated by reference.

### STATEMENT REGARDING FEDERALLY SPONSORED RESEARCH

This invention was made with government support under Grant No. NSF CMMI-0926969 awarded by the National Science Foundation. The government has certain rights in the invention.

### TECHNOLOGICAL FIELD

The present disclosure relates to the field of microfluidic devices, and more particularly, to methods of modifying microfluidic devices by coating the interior surfaces of the devices with solvent resistant coatings.

### BACKGROUND

Microfluidic drug delivery systems can be implanted in living organisms, such as in the eye of a human being. Microfluidic devices have been successfully applied in cell separations, synthesis, and bioanalysis. Glass, silicon, and thiolene devices are highly inflexible and require costly and lengthy fabrication. In contrast, inexpensive elastomeric polydimethylsiloxane (PDMS) allows for facile multi-layer fabrication and direct integration of pumps, valves, and mixers. However, the permeability of PDMS may cause swelling in the presence of organic solvents and absorption of low-molecular-weight molecules from flow streams. Eliminating these weaknesses may allow for PDMS devices to be used in organic synthesis reactions and analytical techniques that require a fixed concentration of analyte.

Previous methods that attempted to modify pre-assembled channels alter the geometries, may require harmful chemicals, and only coat one device at a time. Paraffin wax and sol-gel coatings are applied by liquid-phase processing. UV-polymerization requires specific mixtures of neutral and charged monomers and can lead to gel formation that may clog the channels.

Fluorocarbons have optimal material properties for use as a barrier coating. For example, fluorinated self-assembled monolayers (SAMs) have been used to modify the surfaces of PDMS slabs. Photocurable perfluoroether, THY, PTFE, and materials may be used to replace PDMS. However, these materials do not have the advantages of PDMS, which is easily fabricated into complex networks and does not require complex synthesis.

### SUMMARY

The present disclosure identifies a method to modify the interior surfaces of substrates, such as pre-assembled microfluidic devices, with thin layers of fluoropolymer coatings via initiated chemical vapor deposition (iCVD).

In one embodiment, the method comprises heating a gas comprising a periluoroacrylate, a crosslinker and an initiator at a first temperature, maintaining a substrate at a second temperature lower than the first temperature in a reaction chamber, exposing the heated gas to the substrate in the reaction chamber, and reacting the perfluoroacrylate with the initiator and crosslinker to form a polymer coating on the surface of the substrate.

In some embodiments, the first temperature may be from about 180° C. to about 25° C. The second temperature may be from about 25° C. to about 40° C.

The pressure inside the reaction chamber while forming the coating may be from about 100 mTorr to about 200 mTorr.

In certain embodiments, the concentration of the crosslinker and a concentration of the perfluoroacrylate in the gas is in a ratio of greater than 0 to less than 7:1. The ratio of the concentration of crosslinker to perfluoroacrylate may be from about 7:2 to about 5:1.

The perfluoroacrylate may be 1H,1H,2H,2H-perfluorodecyl acrylate (PFDA).

The substrate may comprise poly(dimethylsiloxane).

The crosslinker may comprise at least one of ethylene glycol diacrylate or ethylene glycol dimethacrylate.

The present disclosure is also directed toward a microfluidic device which may comprise an interior surface; and a coating on the interior surface, the coating on the interior surface comprising a crosslinked polymer, the crosslinked polymer comprising perfluoroacrylate repeat units, and a crosslinker.

The interior surface may comprise at least one channel having a width of greater than about 100 μm and less than about 1000 μm. The channel may also have a height of greater than about 50 μm and less than about 1000 μm. The channel may also have a length of greater than 1000 μm.

### BRIEF DESCRIPTION OF THE DRAWINGS

The drawings disclose illustrative embodiments. They do not set forth all embodiments. Other embodiments may be used in addition or instead. Details which may be apparent or unnecessary may be omitted to save space or for more effective illustration. Conversely, some embodiments may be practiced without all of the details which are disclosed. When the same numeral appears in different drawings, it refers to the same or like components or steps.

FIG. 1a illustrates a cross-section of a reaction chamber according to a method of forming a coating according to one embodiment of the present disclosure.

FIG. 1b is a top view of a microfluidic device having a coating according to another embodiment of the present disclosure.

FIGS. 2a-c show physical and graphical representations of Rhodamine B fluorescence intensity measurements of substrates with a) no coating, b) a coating made with no crosslinker, and c) a coating made with PFDA and crosslinker according to one embodiment of the present disclosure.

FIGS. 3a-c show lengths of hexane droplets measured at (a) the point of formation and (b) the end of the channel for the substrates shown in FIGS. 2a-c.

### DETAILED DESCRIPTION

Illustrative embodiments are now discussed and illustrated. Other embodiments may be used in addition or instead. Details which may be apparent or unnecessary may be omitted to save space or for a more effective presentation. Conversely, some embodiments may be practiced without all of the details which are disclosed.

Surfaces of substrates, such as the interior surfaces of pre-assembled microfluidic devices, may be modified with a crosslinked fluoropolymer coating that significantly increases the chemical compatibility of the devices. The coating may be applied to the interior surface by initiated chemical vapor deposition (iCVD).

ICVD is a useful technique for depositing polymeric thin films. In a typical chemical vapor deposition (CVD) process, the wafer (substrate) is exposed to one or more volatile precursors, which react and/or decompose on the substrate surface to produce the desired deposit. In ICVD, thin films of application-specific polymers may be deposited in one step without the use of solvents. The uniqueness of in situ surface polymer synthesis distinguishes iCVD from conventional processes such as spin-on deposition and plasma-enhanced chemical vapor deposition.

ICVD allows engineering polymers to be made with specific microscale properties translating to well-defined macroscale behaviors. In addition, the use of solventless vapor-phase polymerization to apply polymer coatings eliminates monomer solubility and solvent compatibility issues typically associated with liquid-phase polymerization.

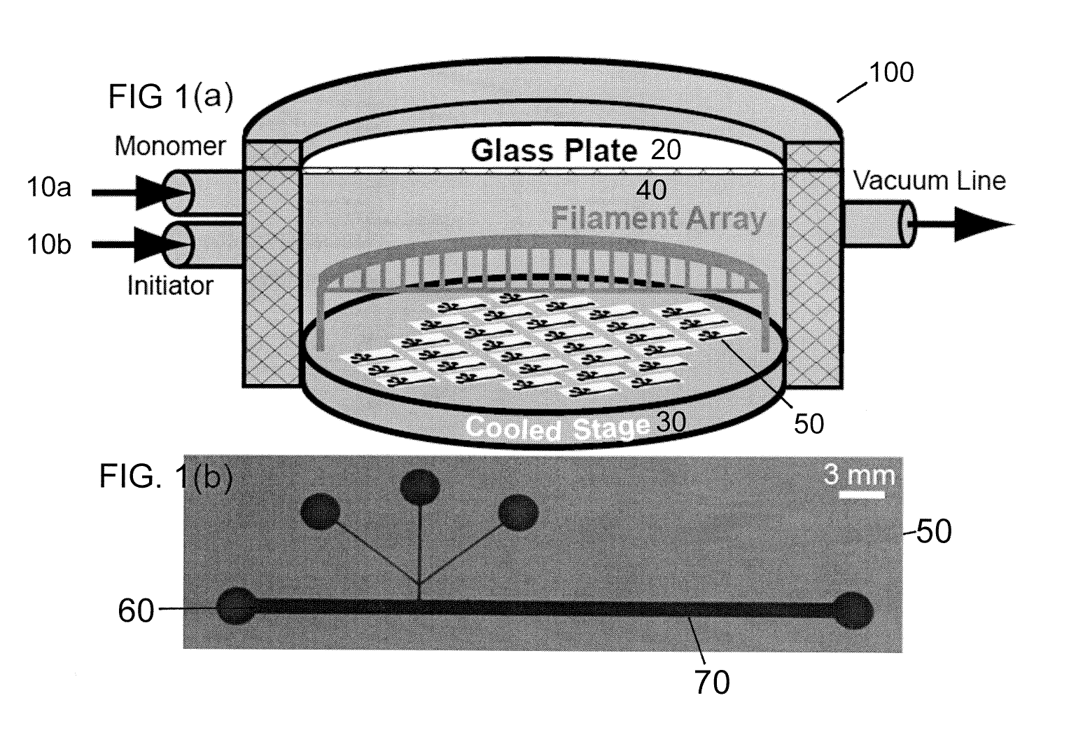

For example, as shown in FIG. 1a, in iCVD, gases comprising a perfluoroacrylate, a crosslinker, and an initiator flow into a reaction chamber 100 covered by a glass plate 20 via inlets 10a, 10b where the gas contacts resistively heated filaments 40 aligned in an array. The initiator breaks down into radicals, beginning a free-radical polymerization of the monomer and crosslinker at the substrate surface on the cooled stage 30. In the example shown in FIG. 1a, the substrate comprises a plurality of microfluidic devices 50.

Any type of perfluoroacrylate that can be used to form a polymeric coating may be used. Examples of perfluoroacrylates that may be used in the present disclosure include fluorine-substituted alkyl chain acrylates, various cyclic fluorine-substituted acrylates, and the like.

The degree of fluorine substitution may vary. The number of fluorine groups substituting hydrogen atoms may be from one to all H groups on the alkyl group. In addition, methacrylate groups may be included in the class of acrylates for use in the present disclosure.

A specific example of a perfluoroacrylate used in the present disclosure is 1H,1H,2H,2H-perfluorodecyl acrylate (PFDA).

The type of crosslinker used in the present disclosure may by any that allows for crosslinking of the perfluoroacrylate. Specific examples of crosslinkers used in the present disclosure include ethylene glycol diacrylate (EGDA) and ethylene glycol dimethacrylate (EGDMA). However, the present application is not limited to these examples, and may use any crosslinker suitable for use with perfluoroacrylate monomers.

The initiator used in the present disclosure may be any initiator suitable for promoting the generation of free radicals to initiate free radical polymerization. One example of an initiator used in the present embodiments is di-tert-butyl peroxide (DTBP).

Since PDMS is permeable to gases, the precursor molecules can diffuse into the PDMS before polymerizing. Fluorocarbons have a low solubility in PDMS; therefore, the PFDA molecules likely remain on the PDMS surface and do not diffuse into the bulk. Due to their low molecular weight, DTBP initiator radicals (MW-73) can readily diffuse into the PDMS; however, EGDA (MW-170) diffuses more slowly due to its larger size. Accordingly, an excess of DTBP initiator may be used to compensate for the decrease in surface concentration due to diffusion into the PDMS. However, any amount of initiator that is suitable to allow for the polymerization reaction to occur may be used.

The temperature at which the substrate is maintained may be lower than the temperature of the filament. The heated gas comprising the reaction components is exposed to the cooler substrate, and allows for condensation of the gas onto the substrate in the reaction chamber. On the substrate, the gas components react to form a polymer coating on the surface of the substrate.

The temperature of the heated gas may be any temperature sufficient to allow for conversion of the initiator to form free radicals. In some embodiments, the temperature of the heated gas is from about 180° C. to about 250° C.

The temperature of the substrate may be any temperature suitable to allow for the perfluoroacrylate, crosslinker, and initiator to condense and react to form a polymer coating on the substrate. In some embodiments the temperature of the substrate is from about 25° C. to about 40° C.

In order for the monomer and initiator molecules to diffuse through narrow channel inlets of the substrate, down the length of the channel, and then react on the channel surface, low operating pressures may be required to facilitate transport of the precursor molecules in the channels. In some embodiments, the pressure inside the reaction chamber while forming the coating is from about 100 mTorr to about 200 mTorr.

As indicated, the method above may be used to make a microfluidic device 50 comprising an interior surface; and a coating on the interior surface. For example, as shown in FIG. 1b, the interior surface may include at least one channel 60.

In some embodiments, the channel may have a width of greater than about 100 μm and less than about 1000 μm. In other embodiments, the channel 60 may have a height of greater than about 50 μm and less than about 1000 μm. The length of the channel 60 may be greater than 1000 μm and may be as high as 50 mm in length.

The iCVD process may produce films with various crosslinking densities by varying the concentration of crosslinker, for example, by modulating the crosslinker flow rate. The crosslinker density may have a significant effect on the efficacy of the coating formed on the substrate 50. The variations in crosslinking density lead to differences in the composition of the film and thus the surface energy that could be observed in contact angle measurements.

Examples of the present disclosure are shown and described herein. It is to be understood that the disclosure is capable of use in various other combinations and environments and is capable of changes or modifications within the scope of the inventive concepts as expressed herein.

### Example

Pre-assembled PDMS microfluidic devices were fabricated using conventional soft lithography methods and then modified in a custom-designed iCVD chamber (GVD Corporation) such as shown in FIG. 1a. The reactor pressure was 125 mTorr, the stage temperature was 35° C., and the filament temperature was 200° C. The initiator, di-tert-butyl peroxide (DTBP) (98%, Sigma), monomer, 1H,1H,2H,2H-perfluorodecyl acrylate (97%, Sigma), and crosslinker, ethylene glycol diacrylate (90%, Sigma), were used as received. Table 1 shows the flow rates of DTBP, PFDA, and EGDA. A 1 mM solution of Rhodamine B (Alfa Aesar) in water and hexane droplets in a continuous phase of water were driven by syringe pumps in the diffusion and absorption studies.

The iCVD method was used to simultaneously deposit a continuous fluoropolymer film onto the interior surfaces of multiple pre-assembled PDMS channels 60. Devices with a multiple-inlet droplet formation geometry were chosen to demonstrate the utility of the polymer as a coating.

The device contained channels 60 with widths of either 200 or 1000 μm and a uniform height of 450 μm (FIG. 1b). In the iCVD process, monomer and initiator vapors are introduced into a vacuum chamber where a heated filament array decomposes the initiator into free radicals. The free radicals and monomer molecules adsorb onto the surface of a cooled substrate where polymerization occurs via a free radical chain mechanism.

TABLE 1

| | | | | | Rhodamine B | Hexane |
|---|---|---|---|---|---|---|
| | Flow rate (sccm) | | | Contact | Fluorescence | droplet |
| Sample | DTBP | PFDA | EGDA | Angle (°) | intensity at 20 μm | size reduction |
| A | — | — | — | — | 1.18 ± 0.06 | 66 ± 3 |
| B | 2.6 | 0.2 | 0 | 120.1 ± 0.5 | 0.26 ± 0.02 | 29 ± 3 |
| C1 | 2.6 | 0.2 | 0.7 | 120.7 ± 0.8 | 0.00 ± 0.1 | 0.9 ± 0.8 |
| C2 | 2.6 | 0.2 | 1.0 | 107.6 ± 0.7 | 0.11 ± 0.02 | 5 ± 2 |
| C3 | 2.6 | 0.2 | 1.4 | 82.7 ± 1.4 | 0.33 ± 0.06 | 33 ± 4 |
| C4 | 2.6 | 0 | 0.7 | 62.3 ± 2.1 | — | — |

As shown in Table 1, a series of sample coatings were prepared on PDMS microfluidic devices having interior channels.

In sample A, a device having no coating was used as a control. In sample C4, a coating comprised only of a crosslinker, homopolymer poly(EGDA), exhibited a contact angle of 62.3±2.1°. In sample B, a coating comprised only of homopolymer poly(PFDA) exhibited a contact angle of 120.1±0.5°. In samples C1-C4, four films were prepared by varying EGDA flowrates ranging from 0.7 to 1.4 sccm, and the contact angles were measured. The results showed that the contact angle of the coating was inversely proportional to the EGDA concentration. Based on absorption and swelling studies, an EGDA flow rate of 0.7 sccm (Sample C1) resulted in the best crosslinking density under these conditions. In sample C1, the contact angle on the polymer was 120.7±0.8°, similar to the homopolymer poly (PFDA) film.

To confirm that samples C1-C3 were crosslinked, the solubility of the crosslinked films to the homopolymer films in the fluorinated solvent hexafluoroisopropanol (HFIP) was compared. The uncrosslinked poly(PFDA) films dissolved in HFIP, while the crosslinked films were insoluble in HFIP after soaking for more than a week. The high contact angle indicates that at the surface the fluorinated groups are present in a higher concentration than the crosslinker molecules.

To demonstrate that the polymer film coated the entire luminal surface, a PDMS slab with the channel imprint was reversibly bonded to a silicon wafer and exposed to the iCVD process. After the deposition, the slab was peeled off and the resultant coating was a continuous film of poly(PFDA-co-EGDA) in the unmasked region as shown in FIG. 1b. Unlike previous modification techniques that visibly roughen the channel surface or alter the geometry of the channel, the iCVD technique creates a transparent film that does not impede optical or fluorescent imaging inside the channel and does not alter the channel geometry

The ability to use the fluoropolymer coatings to prevent absorption of low-molecular weight molecules and resist swelling in the presence of organic solvents was measured. Rhodamine B was used as a low molecular weight molecule because it has been shown to isotropically diffuse through unmodified PDMS.

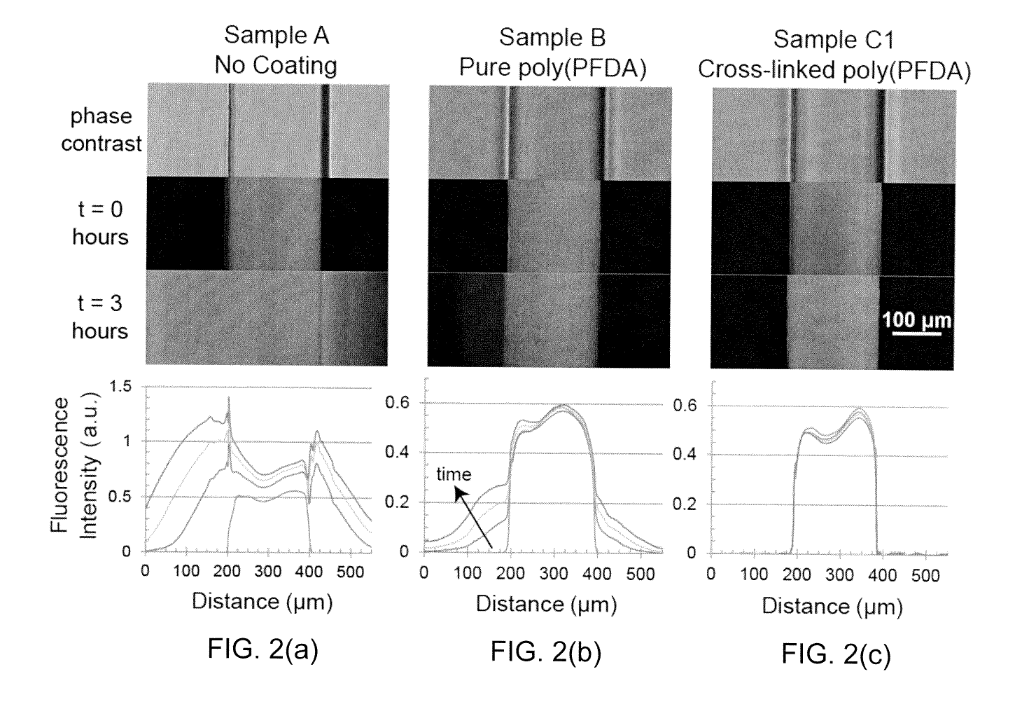

The diffusion was tracked by measuring the fluorescence intensity as a function of the distance from the channel wall as shown in FIGS. 2a-c.

After 3 h of continuous flow, the fluorescence intensity of Rhodamine B was measured 20 μm from the wall of the unmodified channel (sample A) as 1.18±0.06 (a.u.). This compares to a value of 0.26±0.02 for a channel modified with poly(PFDA) (sample B). Although the fluorescence intensity decreased, there was still isotropic diffusion, indicating that Rhodamine B was still partitioning into the channel walls. The hexane droplet decreased in size by 66±3% and 29±3% in samples A and B respectively. Since hexane does not swell the poly(PFDA) polymer, the reduction in size can be attributed to hexane swelling the PDMS.

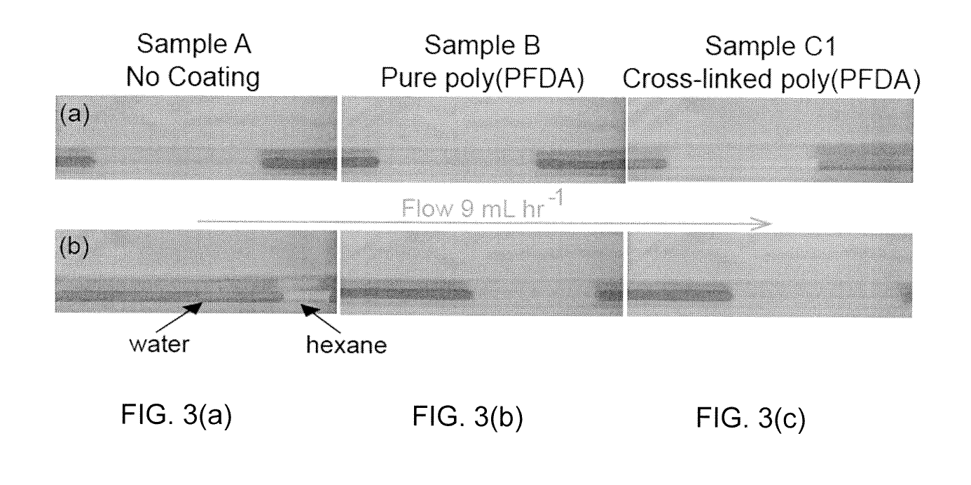

To analyze PDMS swelling, hexane droplets were injected into a continuous aqueous stream. The change in the size of the droplets was analyzed. This analysis showed that larger size reductions indicated that more hexane partitioned into the PDMS, as shown in FIGS. 3a-c. For example, in sample A that had no coating, the reduction was the greatest, whereas in sample C1, which had a crosslinked poly-PFDA coating, the reduction was minimal.

Crosslinking the PFDA stabilizes the coating by overcoming the weak cohesive forces that are known to exist between linear chains with fluoroalkyl moieties. Analysis of Sample C1 showed no significant diffusion of Rhodamine B into the PDMS after 3 h and no swelling due to hexane absorption. The fluorescence intensity 20 μm from the channel wall and the hexane droplet size both remained unchanged to within experimental error. Films with higher crosslinking densities (samples C2 and C3) were not as effective at preventing diffusion and swelling due to the increased concentration of EGDA. Sample C2 outperformed the homopolymer poly(PFDA) coating, indicating that the benefits of crosslinking outweighed the loss of fluorocarbon concentration. However, in sample C3, the EGDA concentration was too high and the decreased relative fluorocarbon concentration led to loss in barrier performance. There is therefore a trade-off between film stabilization due to crosslinking and solvent exclusion optimized at high fluorocarbon concentrations.

Thus, by tuning the crosslinking density, the poly(PFDA-co-EGDA) coating can both inhibit PDMS absorption of Rhodamine B and significantly suppress PDMS swelling in the presence of hexane.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications which are set forth in this specification are approximate, not exact. They are intended to have a reasonable range which is consistent with the functions to which they relate and with what is customary in the art to which they pertain.

All articles, patents, patent applications, and other publications which have been cited are hereby incorporated herein by reference.

What is claimed is:

1. A method of coating a substrate comprising:
heating a gas comprising: a perfluoroacrylate, a crosslinker and an initiator at a first temperature;
maintaining the substrate at a second temperature lower than the first temperature in a reaction chamber;
exposing the heated gas to the substrate in the reaction chamber; and
reacting the perfluoroacrylate with the initiator and crosslinker to form a polymer coating on the surface of the substrate.

2. The method of claim 1, wherein the first temperature is from about 180° C. to about 250° C.

3. The method of claim 1, wherein the second temperature is from about 25° C. to about 40° C.

4. The method of claim 1, wherein the pressure inside the reaction chamber while forming the coating is from about 100 mTorr to about 200 mTorr.

5. The method of claim 1, wherein a concentration of the crosslinker and a concentration of the perfluoroacrylate in the gas is in a ratio of greater than 0 to less than 7:1.

6. The method of claim 5, wherein the ratio is from about 7:2 to about 5:1.

7. The method of claim 1, wherein the perfluoroacrylate is 1H,1H,2H,2H-perfluorodecyl acrylate.

8. The method of claim 1, wherein the substrate comprises poly(dimethylsiloxane).

9. The method of claim 1, wherein the crosslinker comprises at least one of ethylene glycol diacrylate or ethylene glycol dimethacrylate.

10. The method of claim 1, wherein the substrate comprises an interior surface.

11. The method of claim 10, wherein the interior surface comprises at least one channel having a width of greater than about 100 μm and less than about 1000 μm, a height of greater than about 50 μm and less than about 1000 μm, and a length of greater than 1000 μm.

12. A microfluidic device comprising:
an interior surface; and
a coating on the interior surface, wherein the coating on the interior surface comprises a crosslinked polymer, the crosslinked polymer comprising perfluoroacrylate repeat units, and a crosslinker.

13. The microfluidic device of claim 12, wherein the interior surface comprises at least one channel having a width of greater than about 100 μm and less than about 1000 μm, a height of greater than about 50 μm and less than about 1000 μm, and a length of greater than 1000 μm.

14. The microfluidic device of claim 12, wherein the microfluidic device is comprised of poly(dimethylsiloxane).

15. The microfluidic device of claim 12, wherein the crosslinker comprises at least one of ethylene glycol diacrylate or ethylene glycol dimethacrylate.

16. The microfluidic device of claim 12, wherein the perfluoroacrylate is 1H,1H,2H,2H-perfluorodecyl acrylate.

17. The microfluidic device of claim 12, wherein a concentration of the crosslinker and a concentration of the perfluoroacrylate in the coating is in a ratio of greater than 0 to less than 7:1.

18. The microfluidic device of claim 17, wherein the ratio is from about 7:2 to about 5:1.
